(19) United States
(12) Patent Application Publication
(10) Pub. No.: US 2021/0048149 A1
(43) Pub. Date: Feb. 18, 2021

(54) FILLING SYSTEM SUITABLE FOR SOLID DRAG REDUCING AGENT AND SOLID THICKENER

(71) Applicant: PetroChina Company Ltd., Beijing (CN)

(72) Inventors: Ying Xiong, Beijing (CN); Youquan Liu, Beijing (CN); Yadong Zhang, Beijing (CN); Yuan Xu, Beijing (CN); Xianwu Jing, Beijing (CN); Wei Li, Beijing (CN); Zhiqin Kang, Beijing (CN); Houan Zhou, Beijing (CN); Chao Xiang, Beijing (CN)

(21) Appl. No.: 16/843,396

(22) Filed: Apr. 8, 2020

(30) Foreign Application Priority Data
Aug. 12, 2019 (CN) 201910738804.4

(51) Int. Cl. F17D 1/16; E21B 27/02; E21B 43/25; F17D 1/14; B01F 3/12

(52) U.S. Cl. CPC F17D 1/16; E21B 27/02; E21B 43/25; B01F 2215/0081; B01F 3/1214; B01F 3/1271; B01F 2003/125; F17D 1/14

(57) ABSTRACT

The present invention provides a filling system suitable for a solid drag reducing agent and a solid thickener. The system comprises a raw material storage device, a raw material conveying device, a weight metering device, a feeding funnel, and a disperser. The above-mentioned system controls the feeding speed through the raw material conveying device and the weight metering device, and uses the feeding funnel and the disperser to achieve uniform dispersion of the raw material and water, and finally realizes online filling of the raw material.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### FIELD OF THE INVENTION

The present invention belongs to the technical field of reservoir reconstruction in the process of oil and gas development, and particularly relates to a filling system, which is suitable for filling solid drag reducing agents and solid thickeners.

### BACKGROUND OF THE INVENTION

Fracturing and acidification operations are important reservoir reconstruction measures for oil and gas field development. Solid additives are widely used because of their high content of active ingredients, convenient storage and transportation. Among these solid additives, drag reducing agents and thickeners are all macromolecular polymers. Their liquid mixing process is relatively complicated, and it requires a large continuous mixing truck to prepare a part in a liquid tank in advance, and then replenishes according to the used amount. Alternatively, these powdered solid drag reducing agents or thickeners are sucked into a liquid tank with a stirrer by means of liquid mixing with water impact, and prepared in advance and used directly during construction. Both of these liquid mixing methods require a large number of liquid tanks, and many equipments, and the prepared liquid is susceptible to deterioration during storage. Development of a small system for on-line filling of solid drag reducing agents and solid thickeners, and on-line preparation according to the actual demand for reservoir reconstruction is the focus of current research on fracturing and acidification liquid preparation. Mitsui Cyanamide (Japan), Allied Colloids Inc. (Australia), some U.S. companies, and some Chinese companies have developed polymer dispersion and dissolution systems. All of their principles is to use a screw pump or a volute pump to transport solid powder, and in some systems, a Venturi tube is added to mix the polymer and water. In the end, the dissolution is done in a mixing tank by stirring, which takes a long time, and prepares a low concentration (the rated concentration is no more than 5 g/L), and it is easy to cause “fish eyes” when preparing polymers of high molecular weight.

### SUMMARY OF THE INVENTION

In view of the shortcomings of the prior art, an object of the present invention is to provide a filling system suitable for filling a solid drag reducing agent and a solid thickener. The filling system can realize the online filling of the solid drag reducing agent and the solid thickener, and has the characteristics of real-time adjustment of concentration and high preparation concentration.

In order to achieve the above object, the present invention provides a filling system suitable for a solid drag reducing agent and a solid thickener comprising a raw material storage device, a raw material conveying device, a weight metering device, a feeding funnel, and a disperser;

the raw material storage device is connected to the raw material conveying device, so as to convey the raw material into the raw material conveying device; the raw material conveying device is used for conveying the raw material to the feeding funnel; the weight metering device is used for metering the weight of the raw material conveyed by the raw material conveying device to the feeding funnel; the feeding funnel is provided with a water distributor connected to a water source for supplying water to the feeding funnel, and in the feeding funnel the raw material conveyed by the raw material conveying device into the feeding funnel can contact water entering the feeding funnel through the water distributor; the feeding funnel is connected to the disperser to convey a mixture formed by contacting the raw material with water to the disperser, and the disperser can disperse the raw material in the mixture into water to form a mixture liquid.

In the above-mentioned filling system, preferably, the raw material storage device and the raw material conveying device are both provided on the weight metering device, and the weight metering device can meter the weight of the raw material storage device and the raw material conveying device; the weight of the raw material output from the conveying outlet of the raw material conveying device can be calculated by monitoring in real time the weight data of the weight metering device, so as to meter the weight of the raw material conveyed by the raw material conveying device to the feeding funnel.

In the above-mentioned filling system, preferably, the conveying outlet of the raw material conveying device is located above the feeding inlet of the feeding funnel, so as to convey the raw material from the raw material conveying device to the feeding funnel. More preferably, the conveying outlet of the raw material conveying device is located on the central axis of the feeding inlet of the feeding funnel, which is more beneficial for the raw material output from the conveying outlet of the raw material conveying device to enter the feeding funnel through the feeding inlet of the feeding funnel.

In the above-mentioned filling system, preferably, the filling system further comprises a water conveying device connected to a water source for supplying water to the feeding funnel.

In the above-mentioned filling system, preferably, the filling system further comprises a control cabinet; when the filling system comprises a water conveying device, the control cabinet is connected to at least one of the raw material conveying device, the weight metering device, the disperser, and the water conveying device, so as to realize automatic control of at least one of the raw material conveying device, the weight metering device, the disperser, and the water conveying device; when the filling system does not comprise a water conveying device, the control cabinet is connected to at least one of the material conveying device, the weight metering device, and the disperser, so as to realize automatic control of at least one of the material conveying device, the weight metering device, and the disperser. More preferably, when the filling system comprises the water conveying device, the control cabinet is respectively connected to the raw material conveying device, the weight metering device, the disperser, and the water conveying device, so as to realize automatic control of the raw material conveying device, the weight metering device, the disperser, and the water conveying device; when the filling system does not comprise the water conveying device, the control cabinet is respectively connected to the material conveying device, the weight metering device, and the disperser, so as to realize automatic control of the material conveying device, the weight metering device, and the disperser. The use of a control cabinet can automatically control the agent filling and various liquid mixing procedures.

In a specific embodiment, the above-mentioned filling system comprises: a raw material storage device, a raw material conveying device, a weight metering device, a feeding funnel, a disperser, a water conveying device, and a control cabinet; the raw material storage device is connected to the raw material conveying device, so as to convey the raw material into the raw material conveying device; the conveying outlet of the raw material conveying device is located above the feeding inlet of the feeding funnel, and the raw material conveying device is used for conveying raw material to the feeding funnel; the raw material storage device and the raw material conveying device are both provided on the weight metering device, and the weight metering device can meter the weight of the raw material storage device and the raw material conveying device; the weight metering device meters the weight of the raw material conveyed from the raw material conveying device to the feeding funnel based on the weight change of the raw material storage device and the raw material conveying device; the feeding funnel is provided with a water distributor connected to a water source for supplying water to the feeding funnel, and in the feeding funnel the raw material conveyed by the raw material conveying device into the feeding funnel can contact water entering the feeding funnel through the water distributor; the feeding funnel is connected to the disperser to convey a mixture formed by contacting the raw material with water to the disperser, and the disperser can disperse the raw material in the mixture into water to form a mixture liquid; the control cabinet is connected to the material conveying device, the weight metering device, the disperser, and the water conveying device so as to realize automatic control of the material conveying device, the weight metering device, the disperser and the water conveying device.

In the above-mentioned filling system, preferably, the water distributor is a water pipeline provided in the feeding funnel, and the water pipeline is provided with at least one water outlet, wherein the water pipeline is preferably, but not limited to, an annular water pipeline, and the water pipeline is preferably, but not limited to, provided on the upper part of the feeding funnel; more preferably, the water pipeline is provided with two or more water outlets at equal intervals. In a specific embodiment, the water distributor is an annular water pipeline provided in the feeding funnel, and the annular water pipeline is provided with two or more water outlets at equal intervals. In another specific embodiment, the annular water pipeline is disposed with the central axis of the feeding funnel as the center; in another specific embodiment, the annular water pipeline is provided on the upper part of the feeding funnel.

In the above-mentioned filling system, preferably, a gate valve is provided on a connecting pipeline between the water distributor and the water source; the gate valve can be used to control the flow of water into the feeding funnel. If the water conveying device is provided, when adjusting the flow of the gate valve, it is necessary to pay attention to the matching between the flow and the water conveying device to avoid damage to the water conveying device due to the flow control of the gate valve, for example, when the water conveying device is a water pump of rated power, it should be avoided that the gate valve opening is too small, resulting in too low flow, which will burn the pump.

In the above-mentioned filling system, preferably, the water conveying device is a quantitative conveying device and is used for quantitatively conveying water to the feeding funnel.

In the above-mentioned filling system, preferably, the raw material conveying device is a conveying pump driven by a variable frequency motor.

In the above-mentioned filling system, preferably, the raw material conveying device is a volute pump.

In the above-mentioned filling system, preferably, the weight metering device is an electronic platform scale.

In the above-mentioned filling system, preferably, the disperser is a colloid mill or an emulsification pump.

In the above-mentioned filling system, preferably, the disperser is driven by a variable frequency motor.

In the above-mentioned filling system, preferably, the feeding direction of the disperser (i.e., the direction of the mixture formed by contacting the raw material in the feeding funnel with water as it enters the disperser) is perpendicular to an impeller rotation surface of the disperser for stirring and shearing operations.

In the above-mentioned filling system, preferably, the inner surfaces of the raw material conveying device, the raw material storage device, the disperser, and the feeding funnel in contact with the raw material are coated with Teflon coating.

In the above-mentioned filling system, preferably, the water conveying device is a water pump; the water pump may be, but is not limited to, a submersible pump and a self-priming pump; in an embodiment, a constant flow submersible pump is used; and in another embodiment, a constant flow self-priming pump is used.

In the above-mentioned filling system, the raw material storage device may be, but is not limited to, a powder storage funnel.

In the above-mentioned filling system, the outlet of the disperser may be, but is not limited to, connected to the blender hopper or blender tank of the fracturing blender truck. In a specific embodiment, the outlet of the disperser is connected to the blender hopper or blender tank of the fracturing blender truck with a lined steel wire pipeline.

The above-mentioned filling system provided by the present invention can be installed on a skid to realize the skid mounting of the above-mentioned filling system.

In a specific embodiment, the above-mentioned filling system comprises: a raw material storage device, a raw material conveying device, a weight metering device, a feeding funnel, a disperser, a water conveying device, and a control cabinet;

the raw material storage device is a powder storage funnel;

the material conveying device is a volute pump driven by a variable frequency motor, wherein a pump bearing of the volute pump is connected to a bearing of the variable frequency motor;

the weight metering device is an electronic platform scale;

the disperser is a colloid mill driven by a variable frequency motor or an emulsification pump driven by a variable frequency motor, wherein when the disperser is a colloid mill driven by a variable frequency motor, a bearing of the variable frequency motor is connected to a bearing of the colloid mill, and the feeding direction of the colloid mill is perpendicular to an impeller rotation surface of the colloid mill for stirring and shearing operations; when the disperser is an emulsification pump driven by a variable frequency motor, a bearing of the variable frequency motor is connected to a bearing of the emulsification pump, and the feeding direction of the emulsification pump is perpendicular to an impeller rotation surface of the emulsification pump for stirring and shearing operations;

the water conveying device is a constant flow water pump, and the water conveying device is used to supply water to the feeding funnel;

an annular water pipeline is provided in the feeding funnel, wherein the annular water pipeline is disposed with the central axis of the feeding funnel as the center, and at least one water outlet is provided on the annular water pipeline;

the powder storage funnel is connected to the volute pump, so as to convey the raw material to the volute pump driven by a variable frequency motor;

the conveying outlet of the volute pump driven by a variable frequency motor is located above the feeding inlet of the feeding funnel, and the volute pump driven by a variable frequency motor is used to convey the raw material to the feeding funnel;

the powder storage funnel and the volute pump driven by a variable frequency motor (including the variable frequency motor) are both arranged on the electronic platform scale, and the electronic platform scale can meter the weight of the powder storage funnel and the volute pump driven by a variable frequency motor (including the variable frequency motor); the weight metering device meters the weight of the raw material conveyed by the volute pump to the feeding funnel based on the weight changes of the powder storage funnel and the volute pump driven by a variable frequency motor;

the annular water pipeline is connected to the water conveying device for supplying water to the feeding funnel, wherein a valve is provided on a pipeline connecting the annular water pipeline and the constant flow water pump; in the feeding funnel the raw material conveyed into the feeding funnel by the volute pump can contact water entering the feeding funnel through the annular water pipeline;

the feeding funnel is connected to the disperser to convey a mixture formed by contacting the raw material with water to the disperser, and the disperser can disperse the raw material in the mixture into water to form a mixture liquid;

the control cabinet is respectively connected to the variable frequency motor of the raw material conveying device, the electronic platform scale, the variable frequency motor of the disperser, and the constant flow pump, and the control cabinet controls on-off and frequency of the variable frequency motor of the raw material conveying device and the variable frequency motor of the disperser, on-off of the constant flow pump, and monitors in real time the weighing data of the electronic platform scale.

The above-mentioned filling system provided by the present invention mainly relies on the raw material conveying device for feeding, and the feeding speed is controlled by the raw material conveying device and the weight metering device to realize the real-time regulation of the feed concentration, and the feeding funnel is used to contact the water with the raw material to achieve the preliminary mixing of the raw material with water so that the raw material are preliminarily dispersed in the water, and the disperser is used to mix the raw material with water uniformly to obtain a concentrated liquid in which the raw material is uniformly dispersed in the water, and finally the online filling of the raw material is realized.

The filling system provided by the present invention is suitable for filling a solid drag reducing agent and a solid thickener, can adjust the filling speed and control the filling concentration according to the needs of the site, and use a disperser to mix the solid drag reducing agent and the solid thickener with water and disperse into a homogeneous mixture liquid, and finally realize the online filling of the solid drag reducing agent and the solid thickener.

Compared with the prior art, the present invention has the following advantages:

1. The on-site pipeline connection and disassembly of the filling system provided by the present invention is convenient and fast, which can avoid the time-consuming and labor-intensive processes such as on-site layout, pipeline installation, debugging, and disassembly of large continuous mixing vehicles, and can realize small skid mounting.

2. The filling system provided by the present invention can adjust the filling speed according to on-site requirements.

3. The filling system provided by the present invention has a simple process and low energy consumption, avoids the occurrence of “fish eyes” in the prepared liquid, and can realize the online filling of solid drag reducing agent and solid thickener.

4. The filling system provided by the present invention has a wide application range, and can be used for both the preparation of various fracturing fluids and the preparation of acid fluids.

### BRIEF DESCRIPTION OF THE DRAWINGS

FIG. 1 is a schematic diagram of a filling system provided in Example 1.

wherein:

vertical colloid mill 1; volute pump 2; variable frequency motor 3-1, 3-2;

submersible pump 4; powder storage funnel 5; feeding funnel 6;

electronic platform scale 7; control cabinet 8; valve 9.

### DETAILED DESCRIPTION OF THE INVENTION

In order to more clearly understand the technical features, objectives, and beneficial effects of the present invention, the technical solutions of the present invention are now described in detail below, but cannot be understood as limiting the implementable scope of the present invention.

### Example 1

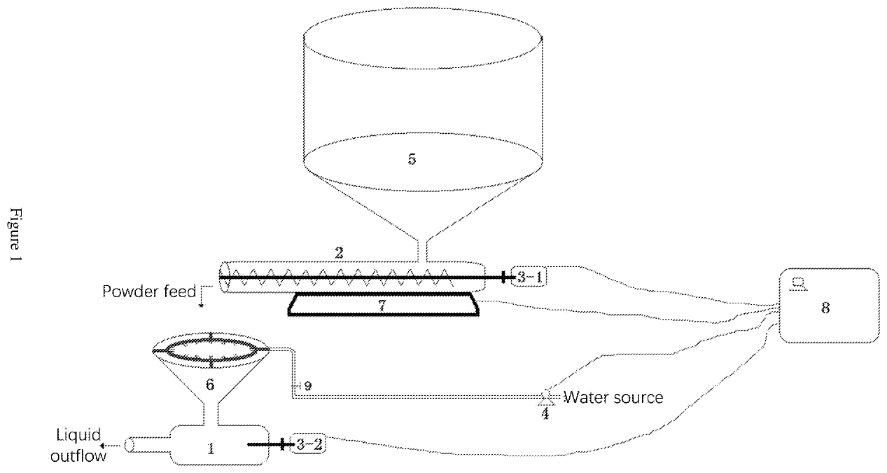

This example provides a filling system suitable for a solid drag reducing agent and a solid thickener, the specific structure of which is shown in FIG. 1.

The system comprises: a raw material storage device, a raw material conveying device, a weight metering device, a feeding funnel 6, a disperser, a water conveying device, and a control cabinet 8; wherein

the raw material storage device is a powder storage funnel 5; the raw material conveying device is a volute pump 2 driven by a variable frequency motor 3-1, wherein the variable frequency motor 3-1 is a three-phase variable frequency motor, and a pump bearing of the volute pump 2 is connected to a bearing of the variable frequency motor 3-1; the weight metering device is an electronic platform scale 7; the disperser is a vertical colloid mill 1 driven by a variable frequency motor 3-2, wherein a bearing of the vertical colloid mill 1 is connected to a bearing of the variable frequency motor 3-2; the water conveying device is a submersible pump 4 with a flow rate of 10 cubic meters per hour, and the water conveying device is used to supply water to the feeding funnel 6;

an annular water pipeline is arranged in the feeding funnel 6, wherein the annular water pipeline is disposed with the central axis of the feeding funnel 6 as the center, and a plurality of water outlets are arranged on the annular water pipeline at equal intervals;

the powder storage funnel 5 is connected to the volute pump 2 to convey the raw material to the volute pump 2; the powder storage funnel 5 and the volute pump 2 driven by the variable frequency motor 3-1 (including the variable frequency motor 3-1) are both arranged on the electronic platform scale 7, and the electronic platform scale 7 bears the entire weight of the powder storage funnel 5 and the volute pump 2 driven by the variable frequency motor 3-1 (including the variable frequency motor 3-1); the conveying outlet of the volute pump 2 is located 20 cm directly above the feeding inlet of the feeding funnel 6 and the conveying outlet of the volute pump 2 is located on the central axis of the feeding inlet of the feeding funnel 6, so as to convey the raw material to the feeding funnel 6 by the volute pump 2; the water inlet of the annular water pipeline is connected to the water supply outlet of the submersible pump 4 through a lined steel wire pipeline, wherein a valve 9 is provided on a pipeline connecting the water inlet of the annular water pipeline and the water supply outlet of the submersible pump 4, and in the feeding funnel 6, the raw material conveyed by the raw material conveying device into the feeding funnel 6 can contact water entering the feeding funnel 6 through the water distributor; the feeding funnel 6 is connected to the vertical colloid mill 1 to convey a mixture formed by contacting the raw material with water to the vertical colloid mill 1, and the disperser can disperse the raw material in the mixture into water to form a mixture liquid; the control cabinet 8 is respectively connected to the variable frequency motor 3-1, the electronic platform scale 7, the variable frequency motor 3-2, and the submersible pump 4, and the control cabinet 8 controls the on-off and frequency of the variable frequency motor 3-1 and the variable frequency motor 3-2, and controls the on-off of the submersible pump 4 and monitors in real time the weighing data of the electronic platform scale 7; the feeding direction of the vertical colloid mill 1 is perpendicular to a impeller rotation surface of the vertical colloid mill 1 for stirring and shearing operations.

except the submersible pump 4, other components are mounted on a skid;

wherein the inner surfaces of the powder storage funnel 5, the volute pump 2, the feeding funnel 6, and the vertical colloid mill 1 in contact with the raw material are coated with Teflon coating.

The filling system provided in this Example is used to fill the solid drag reducing agent, and the specific process comprises:

1) connecting the lines and pipelines of the filling system, and connecting the outlet of the vertical colloid mill 1 with a lined steel wire pipeline to the blender hopper or blender tank of the fracturing blender truck, and connecting the pump inlet of the submersible pump 4 to a water source;

2) starting the power supply of the control cabinet 8, starting the electronic platform scale 7 and performing return-to-zero operation of the electronic platform scale 7, then adding the solid drag reducing agent to the powder storage funnel 5, and transferring the weighing data to the control cabinet 8;

3) opening the valve 9, starting the submersible pump 4, and adjusting the opening degree of the valve 9 to supply water to the feeding funnel 6; starting the variable frequency motor 3-2 to drive the vertical colloid mill 1; starting the variable frequency motor 3-1 to drive the volute pump 2; bring the solid drag reducing agent into the powder feeding funnel 6 by the volute pump 2 and preliminarily mixing it with water, sending the mixture after preliminary mixing into the vertical colloid mill 1 for fully mixing to obtain the solid drag reducing agent concentrated solution, discharging it from the outlet of the vertical colloid mill 1, and finally entering the blender hopper or blender tank of the fracturing blender truck, and then mixing with water and other additives for formulation to form a slick water type fracturing fluid.

### Example 2

This example provides a filling system suitable for a solid drag reducing agent and a solid thickener, and the specific structure thereof is similar to the filling system provided in Example 1, with the only difference in that the disperser is different and the water conveying device is different.

The system comprises: a raw material storage device, a raw material conveying device, a weight metering device, a feeding funnel, a disperser, a water conveying device, and a control cabinet; wherein

the raw material storage device is a powder storage funnel; the material conveying device is a volute pump driven by a first variable frequency motor, wherein the first variable frequency motor is a three-phase variable frequency motor, and a pump bearing of the volute pump is connected to a bearing of the first variable frequency motor; the weight metering device is an electronic platform scale; the disperser is a horizontal emulsification pump driven by a second variable frequency motor, wherein the second variable frequency motor is a three-phase variable frequency motor, and a pump bearing of the horizontal emulsification pump is connected to a bearing of the second variable frequency motor; the water conveying device is a self-priming pump with a flow rate of 10 cubic meters per hour, and the water conveying device is used to supply water to the feeding funnel;

an annular water pipeline is arranged in the feeding funnel, wherein the annular water pipeline is disposed with the central axis of the feeding funnel as the center, and a plurality of water outlets are arranged on the annular water pipeline at equal intervals;

the powder storage funnel is connected to the volute pump to convey the raw material to the volute pump; the powder storage funnel and the volute pump driven by the first variable frequency motor (including the first variable frequency motor) are both arranged on the electronic platform scale, and the electronic platform scale bears the entire weight of the powder storage funnel and the volute pump driven by the first variable frequency motor (including the first variable frequency motor); the conveying outlet of the volute pump is located 15 cm directly above the feeding inlet of the feeding funnel and the conveying outlet of the volute pump is located on the central axis of the feeding inlet of the feeding funnel, so as to convey the raw material to the feeding funnel by the volute pump; the water inlet of the annular water pipeline is connected to the water supply outlet of the self-priming pump, wherein a valve is provided on a pipeline connecting the water inlet of the annular water pipeline and the water supply outlet of the self-priming pump through a lined steel wire pipeline, and in the feeding funnel, the raw material conveyed by the raw material conveying device into the feeding funnel can contact water entering the feeding funnel through the water distributor; the feeding funnel is connected to the inlet of the horizontal emulsification pump to convey a mixture formed by contacting the raw material with water to the horizontal emulsification pump, and the horizontal emulsification pump can disperse the raw material in the mixture into water to form a mixture liquid; the control cabinet is respectively connected to the first variable frequency motor, the electronic platform scale, the second variable frequency motor, and the self-priming pump, and the control cabinet controls the on-off and frequency of the first variable frequency motor and the second variable frequency motor, and controls the on-off of the self-priming pump and monitors in real time the weighing data of the electronic platform scale; the feeding direction of the horizontal emulsification pump is perpendicular to a impeller rotation surface of the horizontal emulsification pump for stirring and shearing operations.

except the self-priming pump, other components are mounted on a skid;

wherein the inner surfaces of the powder storage funnel, the volute pump, the feeding funnel, and the horizontal emulsification pump in contact with the raw material are coated with Teflon coating.

The filling system provided in this example is used to fill the solid thickener, and the specific process comprises:

1) connecting the lines and pipelines of the filling system, and connecting the outlet of the horizontal emulsification pump with a lined steel pipeline to the blender hopper or blender tank of the fracturing blender truck, and connecting the pump inlet of the self-priming pump to a water source;

2) starting the power supply of the control cabinet, starting the electronic platform scale and performing return-to-zero operation of the electronic platform scale, then adding the solid thickener to the powder storage funnel, and transferring the weighing data to the control cabinet;

3) opening the first valve, starting the self-priming pump, and adjusting the opening degree of the first valve to supply water to the feeding funnel; starting the second variable frequency motor to drive the horizontal emulsification pump; starting the first variable frequency motor to drive the volute pump; bring the solid thickener into the powder feeding funnel by the volute pump and preliminarily mixing it with water, sending the mixture after preliminary mixing into the horizontal emulsification pump for fully mixing to obtain a solid thickener concentrated solution, discharging it from the outlet of the horizontal emulsification pump, and finally entering the blender hopper or blender tank of the fracturing blender truck, and then mixing with water and other additives for formulation to form a glue type fracturing fluid.

What is claimed is:

1. A filling system suitable for a solid drag reducing agent and a solid thickener comprising a raw material storage device, a raw material conveying device, a weight metering device, a feeding funnel, and a disperser;
wherein the raw material storage device is connected to the raw material conveying device, so as to convey the raw material into the raw material conveying device;
wherein the raw material conveying device is used for conveying the raw material to the feeding funnel;
wherein the weight metering device is used for metering the weight of the raw material conveyed by the raw material conveying device to the feeding funnel;
wherein the feeding funnel is provided with a water distributor connected to a water source for supplying water to the feeding funnel, and in the feeding funnel, the raw material conveyed by the raw material conveying device into the feeding funnel can contact water entering the feeding funnel through the water distributor; and
wherein the feeding funnel is connected to the disperser to convey a mixture formed by contacting the raw material with water to the disperser, and the disperser can disperse the raw material in the mixture into water to form a mixture liquid.

2. The filling system according to claim 1, wherein the raw material storage device and the raw material conveying device are both provided on the weight metering device, and the weight metering device can meter the weight of the raw material storage device and the raw material conveying device.

3. The filling system according to claim 1, wherein the conveying outlet of the raw material conveying device is located above the feeding inlet of the feeding funnel, so as to convey the raw material from the raw material conveying device to the feeding funnel.

4. The filling system according to claim 1, wherein the filling system further comprises a water conveying device connected to the water source for supplying water to the feeding funnel of the filling system.

5. The filling system according to claim 4, wherein the filling system further comprises a control cabinet; and
when the filling system comprises a water conveying device, the control cabinet is connected to at least one of the raw material conveying device, the weight metering device, the disperser, and the water conveying device, so as to realize automatic control of at least one of the raw material conveying device, the weight metering device, the disperser, and the water conveying device; or
when the filling system does not comprise a water conveying device, the control cabinet is connected to at least one of the material conveying device, the weight metering device, and the disperser, so as to realize automatic control of at least one of the material conveying device, the weight metering device, and the disperser.

6. The filling system according to claim 1, wherein the filling system comprises: the raw material storage device, the raw material conveying device, the weight metering device, the feeding funnel, the disperser, a water conveying device, and a control cabinet;
the raw material storage device is connected to the raw material conveying device, so as to convey the raw material into the raw material conveying device;
the conveying outlet of the raw material conveying device is located above the feeding inlet of the feeding funnel, and the raw material conveying device is used for conveying raw material to the feeding funnel;
the raw material storage device and the raw material conveying device are both provided on the weight metering device, and the weight metering device can meter the weight of the raw material storage device and the raw material conveying device; the weight metering device meters the weight of the raw material conveyed from the raw material conveying device to the feeding funnel based on the weight change of the raw material storage device and the raw material conveying device;
the feeding funnel is provided with a water distributor connected to a water source for supplying water to the feeding funnel, and in the feeding funnel the raw material conveyed by the raw material conveying device into the feeding funnel can contact water entering the feeding funnel through the water distributor;
the feeding funnel is connected to the disperser to convey a mixture formed by contacting the raw material with water to the disperser, and the disperser can disperse the raw material in the mixture into water to form a mixture liquid;
the water conveying device is connected to the water source for supplying water to the feeding funnel; and
the control cabinet is connected to the material conveying device, the weight metering device, the disperser, and the water conveying device, so as to realize automatic control of the material conveying device, the weight metering device, the disperser and the water conveying device.

7. The filling system according to claim 4, wherein the water conveying device is a quantitative conveying device for quantitatively conveying water to the feeding funnel.

8. The filling system according to claim 6, wherein the water conveying device is a quantitative conveying device for quantitatively conveying water to the feeding funnel.

9. The filling system according to claim 1, wherein the water distributor is an annular water pipeline provided in the feeding funnel, and the annular water pipeline is provided with at least one water outlet.

10. The filling system according to claim 9, wherein the annular water pipeline is provided with two or more water outlets at equal intervals; and the annular water pipeline is disposed with the central axis of the feeding funnel as the center.

11. The filling system according to claim 1, wherein the raw material conveying device is a conveying pump driven by a variable frequency motor.

12. The filling system according to claim 1, wherein the raw material conveying device is a volute pump.

13. The filling system according to claim 1, wherein the disperser is driven by a variable frequency motor.

14. The filling system according to claim 1, wherein the disperser is an emulsification pump or a colloid mill.

15. The filling system according to claim 1, wherein the weight metering device is an electronic platform scale.

16. The filling system according to claim 1, wherein the feeding direction of the disperser is perpendicular to an impeller rotation surface of the disperser for stirring and shearing operations.

17. The filling system according to claim 1, wherein the inner surfaces of the raw material conveying device, the raw material storage device, the disperser, and the feeding funnel in contact with the raw material are coated with Teflon coating.

18. The filling system according to claim 4, wherein the water conveying device is a water pump.

19. The filling system according to claim 6, wherein the water conveying device is a water pump.

20. The filling system according to claim 1, wherein the filling system comprises: the raw material storage device, the raw material conveying device, the weight metering device, the feeding funnel, the disperser, a water conveying device, and a control cabinet;
wherein:
the raw material storage device is a powder storage funnel;
the material conveying device is a volute pump driven by a variable frequency motor, wherein a pump bearing of the volute pump is connected to a bearing of the variable frequency motor;
the weight metering device is an electronic platform scale;
the disperser is a colloid mill driven by a variable frequency motor or an emulsification pump driven by a variable frequency motor, wherein when the disperser is the colloid mill driven by a variable frequency motor, a bearing of the variable frequency motor is connected to a bearing of the colloid mill, and the feeding direction of the colloid mill is perpendicular to an impeller rotation surface of the colloid mill for stirring and shearing operations; when the disperser is the emulsification pump driven by a variable frequency motor, a bearing of the variable frequency motor is connected to a bearing of the emulsification pump, and the feeding direction of the emulsification pump is perpendicular to an impeller rotation surface of the emulsification pump for stirring and shearing operations;
the water conveying device is a constant flow water pump, and the water conveying device is used to supply water to the feeding funnel;
an annular water pipeline is provided in the feeding funnel, wherein the annular water pipeline is disposed with the central axis of the feeding funnel as the center, and at least one water outlet is provided on the annular water pipeline;
the powder storage funnel is connected to the volute pump, so as to convey the raw material to the volute pump driven by a variable frequency motor;
the conveying outlet of the volute pump driven by a variable frequency motor is located above the feeding inlet of the feeding funnel, and the volute pump driven by a variable frequency motor is used to convey the raw material to the feeding funnel;
the powder storage funnel and the volute pump driven by a variable frequency motor are both arranged on the electronic platform scale, and the electronic platform scale can meter the weight of the powder storage funnel and the volute pump driven by a variable frequency motor; the weight metering device meters the weight of the raw material conveyed by the volute pump to the feeding funnel based on the weight changes of the powder storage funnel and the volute pump driven by a variable frequency motor;
the annular water pipeline is connected to the water conveying device for supplying water to the feeding funnel, wherein a valve is provided on a pipeline connecting the annular water pipeline and the constant flow water pump; in the feeding funnel the raw material conveyed into the feeding funnel by the volute pump can contact water entering the feeding funnel through the annular water pipeline;
the feeding funnel is connected to the disperser to convey a mixture formed by contacting the raw material with water to the disperser, and the disperser can disperse the raw material in the mixture into water to form a mixture liquid; and
the control cabinet is respectively connected to the variable frequency motor of the raw material conveying device, the electronic platform scale, the variable frequency motor of the disperser, and the constant flow pump, and the control cabinet controls the on-off and frequency of the variable frequency motor of the raw material conveying device and the variable frequency motor of the disperser, the on-off of the constant flow pump, and monitors in real time the weighing data of the electronic platform scale.
